(19) United States
(12) Patent Application Publication
(10) Pub. No.: US 2002/0129807 A1
(43) Pub. Date: Sep. 19, 2002

(54) Tubular carrier for a core drill

(76) Inventor: Adolfo Cervantes, Oxnard, CA (US)

Correspondence Address: Jack C. Munro, Suite 225, 28720 Roadside Drive, Agoura Hills, CA, 91301, US

(21) Appl. No.: 09/808,968

(22) Filed: Mar. 16, 2001

(51) Int. Cl. B28D 1/02; B28D 1/12

(52) U.S. Cl. 125/12; 125/22

(57) ABSTRACT

A tubular carrier and method of making such on which is to be mounted a plurality of spaced apart cutting segments which then comprises a core drill for cutting into a hard material, such as cement. The main section of the wall surface of the tubular carrier is relieved which forms a decreased diameter relative to the fore end of the tubular carrier on which are mounted the cutting segments. This relieving of the wall of the tubular carrier provides extra distance when operating of the core drill relative to the wall of the hole that is being produced thereby reducing side slap which thereby extends the useful life of the core drill by diminishing the wearing out of the tubular carrier.

### BACKGROUND OF THE INVENTION

1. Field of the Invention

The subject matter of this invention is directed to core drills, and more particularly to an improved method of constructing a core drill and an improved tubular carrier for a core drill.

2. Description of the Related Art

Core drills are commonly used for drilling holes in hard materials, such as concrete and masonry. These holes are then used to support a structural member, such as a post, which is used on a support member for a building structure. A typical core drill is constructed of hard metal, such as steel, and takes the shape of a tube with hardened cutting segments mounted at one end of the tube. The opposite end of the tube is closed but includes structure facilitating attachment to a drilling machine. The cutting segments of the core drill are normally constructed of diamonds but also such have been known to be constructed of silicon carbide. The diamonds are held together within the segment by a suitable resin adhesive.

It is common for the cutting segments to be constructed slightly wider than the body of its tubular carrier. The reason for this is to provide a certain amount of space which is to permit the core drill to be easily rotated within the hole that it is producing. It is common to construct the tubular carriers of core drills to be of the length just slightly larger than the length of the hole that is to be produced and also to have a wall thickness that is just sufficient to provide adequate bonding material for the segments. To make the wall thickness of the tubular carrier greater than what is necessary will cause the tubular carrier, and the ultimate core drill, to be of an increased cost.

Cost of core drills, that are manufactured for the construction industry, is an extremely important factor when determining which core drill will be selected to be purchased. In the manufacturing of any structure, such as a building, it may be necessary to use literally hundreds of core drills. It is common within these core drills to have the cutting segments to wear out or break off of the tubular carrier. In such an instance, if the tubular carrier is not significantly damaged, new cutting segments can be mounted on the tubular carrier thereby not requiring the purchase of new tubular carriers. What wears out tubular carriers is that as the core drill is operated, there is an inherent wobble during this rotation. This wobble results in the wall surface of the tubular carrier slamming up against the wall of the hole. This is called side slap. Normally, it doesn't take the forming of very many holes to where the side slap is sufficient to actually deteriorate the wall surface of the tubular carrier requiring the replacement of the core drill.

Although conventional tubular carriers have a cylindrical exterior wall surface that is less than the outside diameter of the cutting segment, there still is a substantial amount of side slap. In the past, there has been no effort to diminish this side slap in the construction of a core drill. It was just thought to be an inherent problem in the construction of any core drill.

Another problem within drilling of holes in cement is that it takes a certain period of time, and of course depending upon the depth of the hole, can be anywhere from a few seconds to several minutes. This side slap creates friction. This friction slows the rotation of the cutting tool. Slowing of the rotation of the cutting tool extends, and in many cases, will double or more the time required in order to produce the hole. It is common for the contractor to have an employee produce the holes and this employee is generally paid a pretty substantial wage. Therefore, the longer the time that is required in order to produce holes, the more the money that has to be paid to this employee for this service. If the holes could be produced in a shorter period of time, a less cost for producing the holes is obtained.

### SUMMARY OF THE INVENTION

A method of making a tubular carrier to which is to be connected a plurality of cutting segments forming a core drill which requires manufacturing an open ended hollow cylindrical tube of a selected length having a constant wall thickness closing one end of this tube, and at the opposite end of this tube mount the cutting segments. Decreasing the wall thickness of the tube from the closed end to a transition area, which is in close proximity to the open end, with the thickness of the wall surface at this open end being normally the minimum thickness that can be utilized in order to provide sufficient support for mounting of the cutting segments. The transition area comprises an annular tapered collar.

The method of making a tubular carrier where the main section of the tubular carrier of the core drill is at a diameter of approximately 0.016 less than the diameter of the core drill located in the area of the cutting segments.

The method of making a tubular carrier for a core drill which includes a transition area extending from the maximum diameter of the tubular carrier which is located at the cutting segments, which is approximately one inch in length, to connect with the decreased diameter of the main section of the tubular carrier.

The method of making a tubular carrier for a core drill wherein the wall surface of the tube between the annular tapered collar of the transition area and the cutting segments is maintained at the maximum diameter of the tubular carrier.

The method of making a tubular carrier which includes slightly decreasing the wall thickness of the tubular carrier a few thousandths of an inch along the entire length of the tubular carrier prior to further decreasing of the wall thickness of the tubular carrier to produce the added desirable clearance to reduce the production of side slap when producing of the hole.

A tubular carrier to which is to be connected a plurality of cutting segments forming a core drill with this tubular carrier comprising a hollow body having a wall which extends from a fore end to an aft end. The fore end is open and the aft end is closed. The wall surface of the hollow body has a maximum thickness at the fore end with there being an annular transition area which decreases the thickness of the hollow body to a decreased value which is less than the maximum value. This transition area is located directly adjacent the fore end. The hollow body has a main section which extends from the transition area to the aft end with this main section having a thickness at least equal to or less than the decreased value. During rotation of the core drill to produce a hole, there is provided additional distance between the hole of the hole wall and the tubular carrier as the main section is relieved which diminishes side slap of the wall thereby extending the useful life of the core drill.

A tubular carrier to which is to be connected a plurality of cutting segments forming a core drill wherein the maximum thickness of the tubular carrier is only about one-half inch of the total length of the tubular carrier.

A tubular carrier to which is to be connected a plurality of cutting segments forming a core drill wherein the maximum value of thickness of the wall of the tubular carrier is at least 0.080 inches.

A tubular carrier to which is to be connected a plurality of cutting segments forming a core drill wherein the annular transition area formed within the body of the tubular carrier is formed on the exterior surface of the body.

A tubular carrier to which is to be connected a plurality of cutting segments forming a core drill wherein the transition area that is formed on the exterior surface of the hollow body of the tubular carrier is tapered.

A tubular carrier to which is to be connected a plurality of cutting segments forming a core drill wherein the transition area included within the body of the tubular carrier is about one-half inch in length.

A tubular carrier to which is to be connected a plurality of cutting segments forming a core drill wherein the diameter of the main section of the body of the tubular carrier is decreased at least 0.016 of an inch less than the maximum diameter of the tubular carrier.

A tubular carrier to which is to be connected a plurality of cutting segments forming a core drill wherein the transition area which connects between the maximum diameter of the tubular carrier and the decreased diameter of the tubular carrier is located near the fore end of the tubular carrier.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an overall perspective view of the core drill that is produced by utilizing the tubular carrier of the present invention;

FIG. 2 is a side elevational view of the tubular carrier of the present invention prior to the performing of any machining operations thereon;

FIG. 3 is a side elevational view of a nut that is to be mounted in conjunction with one end of the tube of FIG. 2 forming a closed end with the nut being shown in its initial configuration;

FIG. 4 is a side elevational view of the nut of FIG. 3 where one end of the nut has been relieved and formed into a rounded configuration;

FIG. 5 is a longitudinal cross-sectional view through the nut of FIG. 4 showing its connection to a washer which is mounted on the rounded configuration of the nut and also showing the internal threaded through hole that is formed internally of the nut;

FIG. 6 is a view similar to FIG. 5 but showing the washer being mounted within one end of the tube of FIG. 2;

FIG. 7 is a side elevational view, partly in cross-section, of the resultingly formed tubular carrier of the present invention;

FIG. 8 is an enlarged cross-sectional view of the open end of the tubular carrier of the present invention defined by line 8 within FIG. 7;

FIG. 9 is a side elevational view, partly in cross-section, of the resultingly formed core drill which utilizes the tubular carrier of the present invention;

FIG. 10 is an end view of the open end of the core drill of the present invention taken along line 10-10 of FIG. 9; and

FIG. 11 is an enlarged view of the end of the core drill taken along line 11 of FIG. 9.

### DETAILED DESCRIPTION OF THE INVENTION

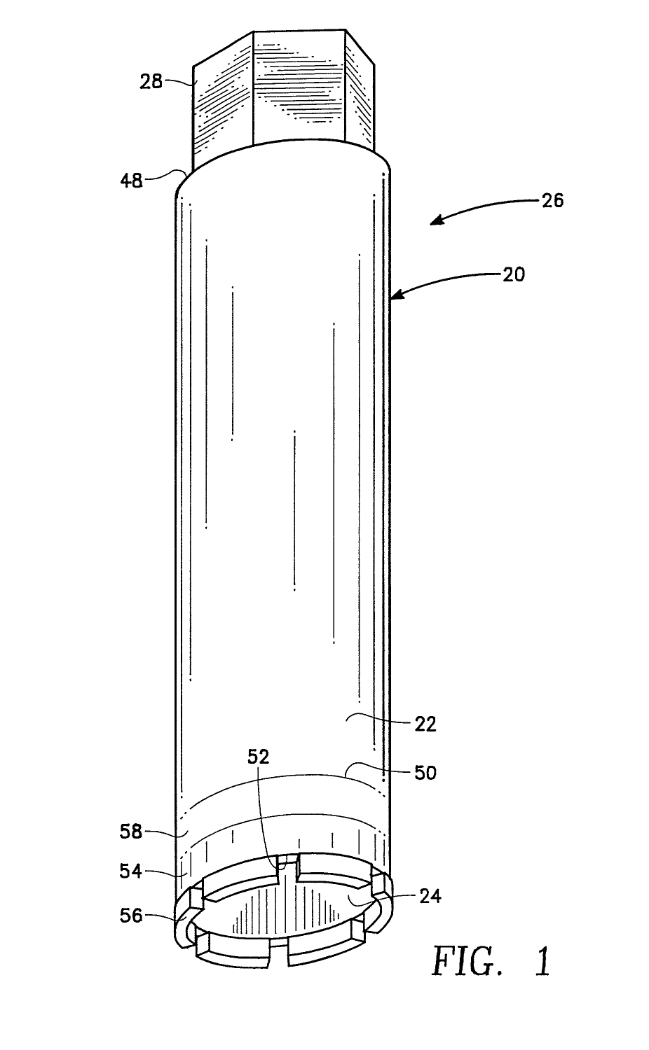

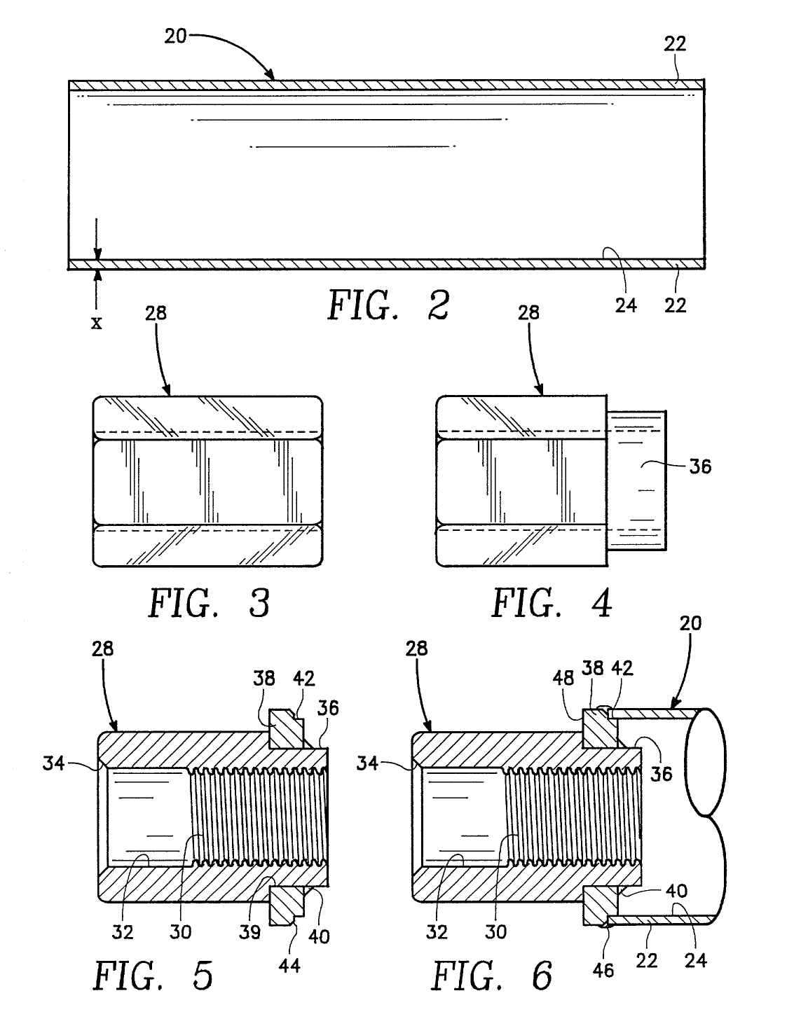

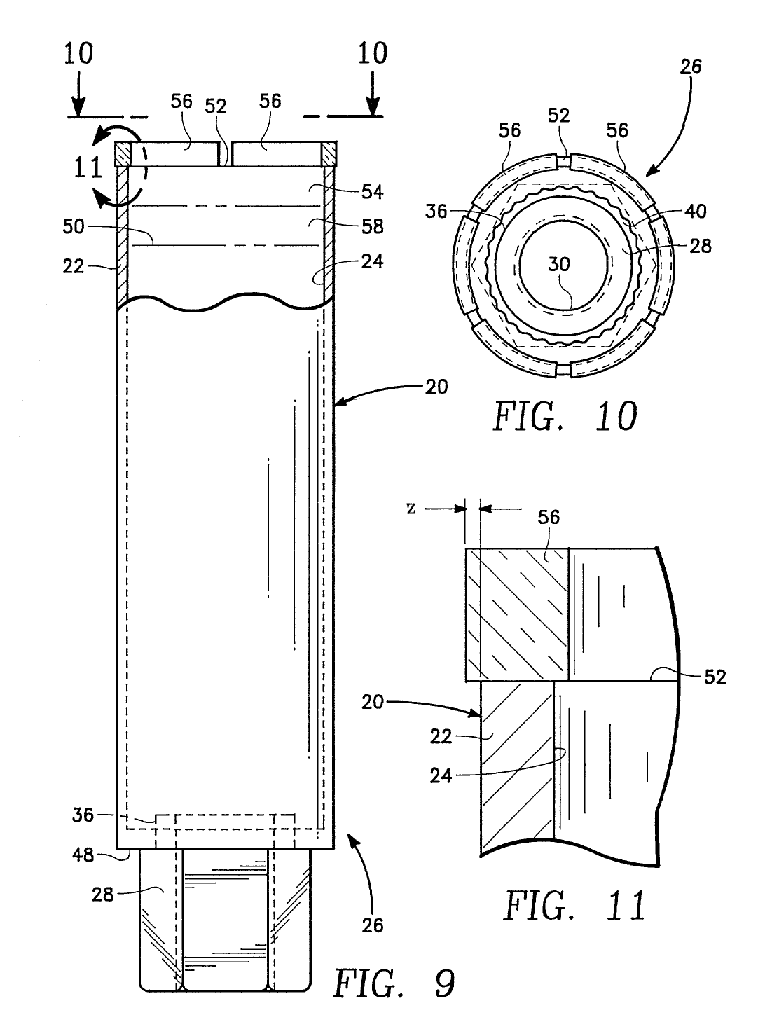

Referring specifically to FIG. 2, there is shown a hollow, cylindrical, steel tube 20. This tube 20 can be manufactured in any desired length with typical lengths being generally between fourteen and twenty-four inches. A typical diameter can be between one-half inch to twenty-four inches. The tube 20 has an exterior surface 22 and an interior through opening 24 which is normally defined as a hollow. The tube 20 has an initial wall thickness X. For example, for a two inch diameter tube 20, the initial wall thickness X would be 0.085 of an inch. For a half inch tube, the wall thickness can be decreased slightly to about 0.080 inches. For a twenty-four inch tube, the wall thickness will be increased to generally be about 0.129 inches. The selection of the wall thickness X is strictly just what is sufficient to give adequate strength to the core drill 26 that is going to be produced using the tube 20 of this invention. The core drill 26 is shown in its entirety in FIGS. 1 and 9 of this invention.

A hexagonal nut 28 is utilized which has a through hole which includes a series of threads 30. There is a non-threaded section 32 of this through opening which extends to an annular chamfer 34 which connects with the outer end of the nut 28. The annular chamfer 34 functions as a guide to facilitate the insertion of a threaded bolt (not shown) which is to threadingly engage with threads 30. This will mount the core drill 26 onto a drilling machine, which is not shown. The function of the drilling machine is to drive the core drill 26 during the operation of the core drill 26.

The lower end of the nut 28 is milled forming a circular end 36. To be mounted on the circular end 36 is a washer 38 with circular end 36 located in center opening 39 of washer 38. This washer 38 is welded by weld 40 to the nut 28. The washer 38 includes an annular relief 42 and an annular chamfer 44. The annular relief 42 is used to accommodate one end of the tube 20. A weld 46 is then applied fixedly securing the tube 20 to the washer 38. This now means that the nut 28, washer 38 and tube 20 are an integral unit.

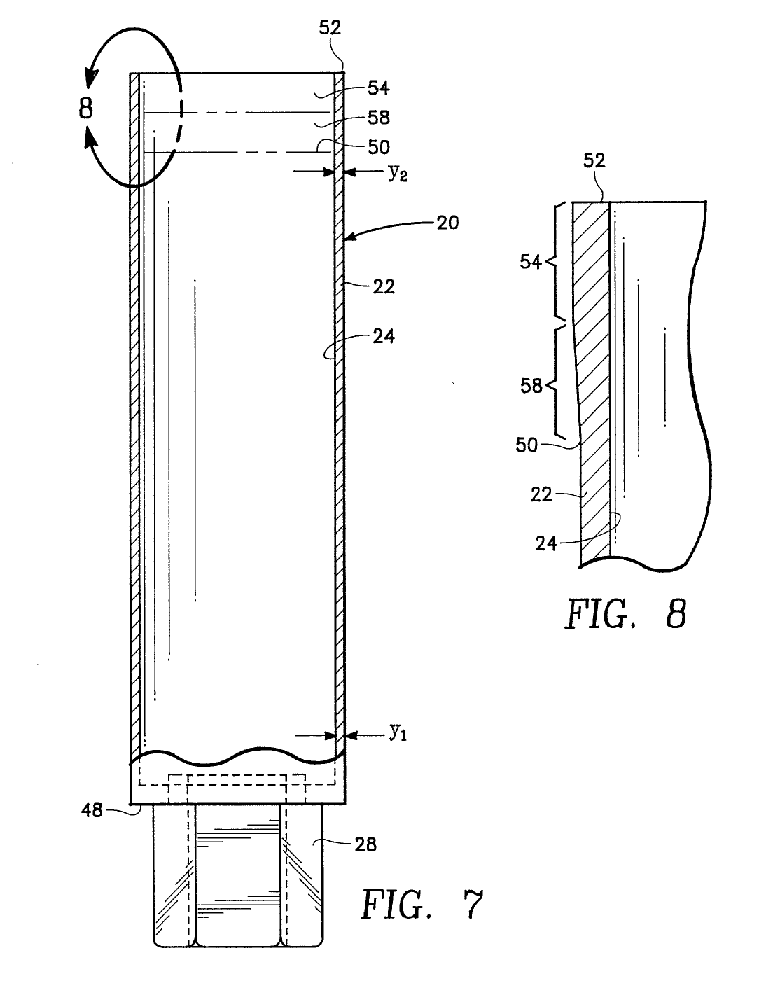

The tube 20 and the nut 28 are now centrally mounted within a lathe and an initial relieving of 0.002 of an inch of material is removed from the entire longitudinal length of the exterior surface 22 of the tube 20. This produces a wall thickness Y1 and Y2, which is shown in FIG. 7. The main section of the exterior surface 22 of the tube 20 is now further relieved an additional relieving of 0.008 of an inch from the aft end 48, which is located directly adjacent the nut 28, to point 50, which is located about one inch from the fore end 52 of the tube 20. The wall thickness Y1, in the case of a two inch tube 20, should now be 0.075 inches. However, Y1 could be 0.075 inches and Y2 could be 0.077 inches with there being a slight taperage between Y1 and Y2. It is possible to combine the initial relieving and additional relieving into a single step. Section 54 of the exterior surface 22, which is about one-half inch in length, is permitted to remain at 0.083 inches. This thickness is necessary to obtain a secure mounting of the cutting segments 56 which are to be mounted on the fore end 52. Between the section 54 and the main section of the exterior surface 22 there is a transition area comprising an annular tapered section 58. The length of the tapered section 58 is generally about one-half inch and its maximum wall thickness is about 0.83 and then decreases to about 0.077 to 0.75 inches, with the wide thickness at Y1 being 0.075 inches.

The tube 20 is to be manufactured in accordance, as previously described, and is to be supplied to an appropriate supplier whose purpose is to mount the cutting segments 56 on the tube 20. The particular type of cutting segment 56, the particular size of cutting segment 56, and also the specific construction of the cutting segment 56 is generally selected by the user. Typically, the cutting segments 56 will be constructed of a resin adhesive within which has been impregnated rough cut diamonds. The segments 56 are generally made in the form of an arc of a circle with it being common that there are a plurality of the segments 56 mounted about the circular fore end 52. In referring to FIG. 10, it can be seen that there is shown six in number of the segments 56. However, a greater or lesser number of the segments could be used mounted in an evenly spaced apart arrangement on fore end 52. Typically each segment 56 will be of a width greater than the width of the tube 20 located at the fore end 52. This means that for a two inch tube 20 that each of the segments 56 will extend laterally outwardly from the exterior surface 22 a few thousands of an inch. This distance is shown as distance Z in FIG. 11. The reason for this outward lateral extension of the cutting segments is so that the hole that is produced within the masonry by using of the core drill 26 will be slightly greater than the two inch diameter of the tube 20. The reason for this is that the structural member that is going to be mounted within the hole, that is produced by the core drill 26, will more than likely be precisely two inches in diameter. Therefore, the hole needs to be just a little bit larger so as to facilitate the insertion of that structural member.

In the performing of the cutting operation utilizing of the core drill 26, the core drill 26 will be rotated rather rapidly with the leading edge of the drilling being the cutting segments 56. Inherently in the rotating of the core drill 26, there will be a tendency for the core drill 26 to wobble. When wobbling, the exterior surface 22 will come into contact with the wall of the hole that is being produced. This is known as side slap, and it is this side slap that creates fiction, and the greater the side slap, the slower the cutting operation and also the greater the wear on the tube 20. If the side slap can be decreased, the cutting operation can be accomplished much faster and also the tube 20 can be reused even after the cutting segments 56 wear out by installing of new cutting segments. This relieving or decreasing of the overall diameter of the tube 20 between point 50 and the aft end 48 by 0.008 of an inch (for a two inch tube) is what achieves this decrease in side slap. Therefore, when the tube wobbles, which it is inherently going to do, the wobble is pretty much performed within a space with only a minimum amount of contact with the wall of the hole occurring.

The present invention may be embodied in other specific forms without departing from the essential attributes thereof. Reference should be made to the appending claims rather than the foregoing specification as indicating the scope of the invention.

What is claimed is:

1. A method of making a tubular carrier to which is to be connected a plurality of cutting segments forming a core drill comprising:
manufacturing an open end hollow cylindrical metallic tube of a selected length having a constant wall thickness and a first precise diameter;
closing of one end of said tube forming a closed end and leaving open the opposite end of said tube forming an open end;
decreasing of said wall thickness of said tube from said closed end to a transition area which is in close proximity to said open end forming a second precise diameter;
decreasing of said wall thickness at said transition area forming an annular tapered collar which connects between said first precise diameter and said second precise diameter; and
leaving the portion of said tube between said collar and said open end at said first precise diameter.

2. The method as defined in claim 1 wherein the second precise diameter is approximately 0.016 of an inch less than said first precise diameter.

3. The method as defined in claim 2 wherein:
said transition area being approximately one-half inch in length.

4. The method as defined in claim 3 wherein:
said portion of the tube between said collar and said open end being approximately one-half inch in length.

5. The method as defined in claim 1 wherein:
between the closing step and the decreasing step there is inserted the additional step of slightly decreasing wall thickness of 0.002 of an inch along the entire length of said tube.

6. A tubular carrier to which is to be connected a plurality of cutting segments forming a core drill, said tubular carrier comprising:
a hollow body having a wall which extends from a fore end to an aft end, said aft end being closed, said fore end having a maximum value of thickness of said wall, said fore end being adapted to have mounted thereon the plurality of cutting segments located in a spaced apart arrangement;
said hollow body having an annular transition area which decreases the thickness of said body to a decreased value, said decreased value being less than said maximum value;
said hollow body having a main section which extends from said transition area to said aft end, said main section being at said decreased value; and
whereby during rotation of said core drill within a hole there is provided an additional distance between the hole wall and said tubular carrier since said main section is at or lower than said decreased value which diminishes side slap of said wall with the whole wall thereby extending the usable life of said tubular carrier.

7. The tubular carrier as defined in claim 6 wherein:
said fore end being approximately one-half inch in length.

8. The tubular carrier as defined in claim 6 wherein:
said maximum value being at least 0.080 inches.

9. The tubular carrier as defined in claim 6 wherein:
said annular transition area being formed on the exterior surface of said tubular carrier.

10. The tubular carrier as defined in claim 6 wherein:
said transition area being tapered.

11. The tubular carrier as defined in claim 10 wherein:
said transition area being approximately one-half inch in length.

12. The tubular carrier as defined in claim 6 wherein:
said decreased value being at least 0.008 of an inch less than said maximum value.

13. The tubular carrier as defined in claim 6 wherein:
said transition area being located directly adjacent said fore end.

14. The tubular carrier as defined in claim 6 wherein:
said decreased value comprising a further decreased value at said aft end and directly adjacent said transition area.

15. The tubular carrier as defined in claim 14 wherein:
said further decreased value being approximately 0.002 of an inch less than said decreased value.
